(19) United States
(12) Patent Application Publication
(10) Pub. No.: US 2017/0183786 A1
(43) Pub. Date: Jun. 29, 2017

(54) METHOD & APPARATUS FOR In Situ Nitrogen Fixation

(71) Applicants: IT (Ed) Chen, Captain Cook, HI (US); Tara Ann Cronin, Captain Cook, HI (US)

(72) Inventors: IT (Ed) Chen, Captain Cook, HI (US); Tara Ann Cronin, Captain Cook, HI (US)

(21) Appl. No.: 14/972,069

(22) Filed: Dec. 16, 2015

(51) Int. Cl. C25B 3/00; C05C 11/00; C05C 3/00; H02S 99/00; B01J 19/08

(52) U.S. Cl. CPC C25B 3/00; H02S 99/00; B01J 19/087; C05C 3/00; C05C 11/00; B01J 2219/0803; B01J 2219/0875

(57) ABSTRACT

This patent describes an invention which fixes nitrogen from the air for agricultural systems. It produces Ammonia, Nitrates, and other NOx from nitrogen, oxygen, and, water vapor by reaction these substances with a metal with current running through it, which has a circuit that generates random spikes in electricity on a metal surface such as a nanostructure mounted catalyst or a catalyst on metal mesh.

### CROSS-REFERENCE TO RELATED APPLICATIONS

The priority of U.S. Provisional Application Ser. No. 62/206360, entitled, “Nitrogen Fixation and other Gaseous Nutrition for Farming systems using a metal mesh or wires and a ac/dc switching power supply.”, filed Aug. 18, 2015, in the name of the inventor Ite Chen is hereby claimed for all common subject matter under 35 U.S.C. §1.19(e).

### STATEMENT REGARDING FEDERALLY SPONSORED RESEARCH OR DEVELOPMENT

Not applicable.

### BACKGROUND

This section introduces information from the art that may be related to or provide context for some aspects of the technique described herein and/or claimed below. This information is background facilitating a better understanding of that which is disclosed herein. This is a discussion of “related” art. That such art is related in no way implies that it is also “prior” art. The related art may or may not be prior art. The discussion is to be read in this light, and not as admissions of prior art.

Nitrogen fixation in agriculture from the air typically relies on bacteria root nodules to fix nitrogen from the air into usable forms of nitrogen such as NO2 and Ammonia. Otherwise, available nitrogen is typically introduced into the ground by using salts of nitrates, or salts of ammonia, as well as other salts such as urea.

However, there is no in situ method to fix nitrogen from the air using catalytic methods, which take the nitrogen, oxygen, and water in the air, as well as other trace gases such as CO2, and convert them into gaseous plant nutrients such as nitric oxide, ammonia, Nitrous Oxide, and Nitrogen Dioxide, as well as ethylene, and carbonates. This invention produces these chemicals from the air at part per million levels and feeds plants at a constant and steady rate which has been demonstrated to increase fruting, flowering, and foliar growth without the need for additional application of nitrogen in the ground.

### SUMMARY

This invention is an in situ method to fix nitrogen from the air using catalytic methods, which take the nitrogen, oxygen, and water in the air, as well as other trace gases such as CO2, and convert them into gaseous plant nutrients such as nitric oxide, ammonia, Nitrous Oxide, and Nitrogen Dioxide, as well as ethylene, and carbonates. This invention produces these chemicals from the air at part per million levels and feeds plants at a constant and steady rate which has been demonstrated to increase fruiting, flowering, and foliar growth without the need for additional application of nitrogen in the ground. The invention dues this by running a DC current through high surface area conductors such as copper wire mesh, coated mesh, mesh coated with nanotubes or nanotubes decorated with metals with a current limiting switching circuit.

The above paragraph presents a simplified summary of the presently disclosed subject matter in order to provide a basic understanding of some aspects thereof. The summary is not an exhaustive overview, nor is it intended to identify key or critical elements to delineate the scope of the subject matter claimed below. Its sole purpose is to present some concepts in a simplified form as a prelude to the more detailed description set forth below.

### DETAILED DESCRIPTION

The technique disclosed herein utilizes catalysts for reaction of gases present in air, in situ producing available nitrogen fertilizer in both gaseous form and aqueous form. The process works by running a DC current through a conductor, such as copper or other metals as well as other conductive material such as carbon nanotubes, graphite, as well as conductors coated with semiconductors such as zinc oxide, and titanium dioxide. The surface of the conductor is exposed to the air while a current runs through the system.

The catalyst may be formed in a variety of manners. For example, the catalyst may include a blend of different known catalysts. The catalyst may be a catalyst drawn into a wire or wire mesh. The process may also occur on pods of metals, conductors, and or semiconductors which are wired together and placed where nitrogen is needed in a food production system.

The nitrogen fixation surface area of the reactive material may include a multi-layered film adhered to a nitrogen fixation system. This multi-layered film may include catalyst particles of different sizes which range from 1 nm to 1000 microns. These catalysts may be conductors, or semiconductors adhered onto a conductor with conducting polymers such as nafion.

Typical nitrogen fixation materials may include conducting carbon blends, wire meshes, metal wires, inorganic oxides, clays and clay minerals, ion-exchanged layered components, diatomaceous earth components, zeolites or a resinous support material, such as a polyolefin, and carbon nanotubes for example. Specific inorganic oxides include silica, alumina, magnesia, titania and zirconia, for example. In one or more embodiments, the support material includes a nanoparticulate material. The term “nanoparticulate material” refers to a material having a particle size smaller than 1,000 nm. Exemplary nanoparticulate materials include, but are not limited to, a plurality of fullerene molecules (i.e., molecules composed entirely of carbon, in the form of a hollow sphere (e.g., buckyballs), ellipsoid or tube (e.g., carbon nanotubes), a plurality of quantum dots (e.g., nanoparticles of a semiconductor material, such as chalcogenides (selenides or sulfides) of metals like cadmium or zinc (CdSe or ZnS, for example), graphite, a plurality of zeolites, or activated carbon. In addition to the non-limiting, exemplary supports listed above, any nitrogen fixation system support known to those skilled in the art may be used depending upon implementation-specific design considerations. Accordingly, other embodiments may employ other supports for the nitrogen fixation system.

Some embodiments may employ an aqueous electrolyte in a closed reaction chamber. The aqueous electrolyte may comprise any ionic substance that dissociates in aqueous solution and does not damage food production systems. Exemplary liquid ionic substances include, rock dusts, volcanic ash, potash, sulfates, carbonates, nitrates, or nitrites with associated metal cations. Air is pumped into the reaction chamber filled with electrolyte or water. The gas reacts with the water and produces nitrates, and ammonia, as well as gaseous available nitrogen.

The presently disclosed technique may also be used to react carbon gases present in air of a gaseous feedstock in some embodiments, which is converted to carbonates and ethylene if water vapor is also present in the air.

The voltage level can be used to control the resulting product. The exact rates and chemicals produced at various voltages ranging from 0.01 V to 1000 V are yet unknown.

The compounds produced can be used in aquaponic systems, hydroponic systems, aeroponic system, traditional agriculture, and organic agriculture.

This method may also be applied to alkalizing the air to aid in fungus growth and fungus based pesticides.

This method may also be applied to speed composting.

This process will allow plants to grow in cold weather and low sunlight.

When combined in a closed area with high levels of co2, plant growth will increase proportionately to the percent change in carbon dioxide from baseline.

### Examples

A PVC pipe is packed with copper mesh. Water and air are pumped through the system which is wired with a DC current running through it with a current limiting switching circuit and the resulting product is pumped into an irrigation system.

Solar panels are connected to wire mesh which is exposed to air. The solar panels act as current limiting switching circuits, as they will operate at a fixed voltage and limited current.

AC/DC switching power supply ranging between 0.01 V to 1000 V is connected to a copper mesh, running DC current from the positive terminal to the negative terminal. The mesh is hung on posts or from tree to tree.

Pods of semi-conductor material such as titanium dioxide is adhered to a conductor and placed on the ground where nitrogen fertilizer is needed.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for nitrogen fixation comprising of:
a conductor or semiconductor or both that is in contact with the atmosphere that is wired to a power source with a current limiting switching circuit or the equivalent and a voltage is applied between 0.01V to 100000 V and the amperage is limited to between 0.01 A to 1000000 A;

2. The conductor or semi-conductor or both that of claim 1 that is coated with another electrical conductor or semiconductor using a conductive adhesive.

3. The method of claim 1, wherein the conductor or semiconductor or both is a wire mesh of any metal or semi-conductor.

4. The method of claim 1 wherein the conductor or semiconductor, or both is a pod that is wired in series or in parallel to a power supply with a current limiting switching circuit or the equivalent.

5. The method of claim 1 wherein the power supply is a single solar panel or a number of solar panels wired in series or in parallel.

6. The method of claim 1 wherein the power supply connected to a number of solar panels wired in series or in parallel.

7. The method of claim 1 wherein additional carbon dioxide is introduced into a closed growing space.

8. The method of claim 1 wherein addition humidity or water vapor is introduced to the surface of the conductor or semi-conductor.

9. A closed reaction chamber filled with a conductor or semi-conductor or both, wherein water and air are pumped through the chamber and the conductor or semi-conductor or both are in contact with the water and air as in claim 1.

10. The method of claim 9 wherein the reaction chamber is connected to an irrigation system.

11. The method of claim 1, wherein varying voltages, amperages, and pulse forms are used.

12. The method of claim 1 wherein the conductor or semi-conductor, or both are elevated above the ground.

13. The method of claim 1 wherein it is applied to aeroponic growing systems.

14. The method of claim 1 wherein it is applied to a hydroponic growing system.

15. The system of claim 9, wherein:
the water contains an electrified slurry of conductive or semiconductor particles.

16. The method of claim 1 in which no power supply is used, and direct solar exposure is used to generate electrons to power the reaction.

17. The system of claim 1 applied to speed composting and fungal growth.

18. The system of claim 9 applied to speed composting and fungal growth.
